(19) United States
(12) Patent Application Publication
(10) Pub. No.: US 2026/0259615 A1
(43) Pub. Date: Sep. 3, 2026

(54) KEYBOARD WITH SWITCHABLE KEYSTROKE SOUND

(71) Applicant: GUANGDONG RUIXUN ELECTRONIC TECHNOLOGY CO., LTD., Guangdong (CN)

(72) Inventors: Dou CHEN, Guangdong (CN); Mingyong TANG, Guangdong (CN); Guangnan ZHU, Guangdong (CN); Jie XIANG, Guangdong (CN); Aihua CHEN, Guangdong (CN); Jianping LI, Guangdong (CN)

(21) Appl. No.: 18/858,344

(22) PCT Filed: Oct. 31, 2023
(86) PCT No.: PCT/CN2023/128436

§ 371 Date: Oct. 21, 2024

(30) Foreign Application Priority Data
Aug. 16, 2023 (CN) 202311033469.0

(51) Int. Cl. G06F 3/023; G06F 3/02

(52) U.S. Cl. CPC G06F 3/0238; G06F 3/0202

(57) ABSTRACT

The present invention discloses a keyboard with a switchable keystroke sound. The keyboard comprises a switch-fixing plate and a plurality of key switches arranged on the switch-fixing plate. The key switches have sound-making structures for making keystroke sounds when pressed. A switching plate that is movable relative to the switch-fixing plate is arranged on a bottom portion of the switch-fixing plate. A plurality of structural members that are stretched into the key switches are configured on the switching plate. The keyboard of the present invention is artful in arranging the movable switching plate at the bottom portion of the keyboard, so as to determine whether the sound-making structures in the key switches can make keystroke sounds by changing the positions of the structural members that are located on the switching plate and stretched into the key switches.

### TECHNICAL FIELD

The present invention relates to a keyboard device, specifically a keyboard with a switchable keystroke sound.

### BACKGROUND OF THE INVENTION

At present, an input device is a device for inputting data and information to a computer, and is a bridge for communication between the computer and a user or other devices, such as a keyboard. The keyboard is a combination of a plurality of key switches.

The text of the Chinese patent for utility model No. 202223562053.1 discloses “ULTRATHIN BALANCE KEY WITH STABLE ASSEMBLY”, and discloses a sound-making key in Embodiment 3: by adding a sound-making mechanism, the key has a sound-making function that it can make a keystroke sound when pressed; the sound-making mechanism is mounted on a linkage wing; a stop dog for limiting a sound-making torsion spring is fixedly mounted on a switch-fixing plate; keyboards of this kind do not have a mute function once they are given the sound function. However, many users hope that a keyboard has both silent and sound modes at the same time, and can switch the modes instantly according to the service environment. Based on this, it is an objective of the present invention to provide a solution of a keyboard with a switchable keystroke sound. The solution at least can be applied to the ultrathin balance key as mentioned above, and without doubt, it is not limited to the ultrathin balance key.

### BRIEF SUMMARY OF THE INVENTION

In light of the above problem, the present invention aims to provide a keyboard with a switchable keystroke sound, which is artful in structure and convenient to use.

To achieve the technical objective, the present invention has a solution as follows: a keyboard with a switchable keystroke sound, which comprises a switch-fixing plate and a plurality of key switches arranged on the switch-fixing plate, wherein the key switches each have a sound-making structure for making a keystroke sound when pressed, a switching plate that is movable relative to the switch-fixing plate is arranged at a bottom portion of the switch-fixing plate, a plurality of structural members that are stretched into the key switches are configured on the switching plate, and the structural members correspond one by one to the key switches;
through holes that allow the structural members to enter corresponding key switches and move along with the switching plate are opened on the switch-fixing plate; positions of the structural members in the corresponding key switches can be changed by moving the switching plate, and state of interaction between the structural members and sound-making structures is changed accordingly, so as to determine whether the sound-making structures make sounds or stay silent when the key switches are pressed.

As a preferred option, the sound-making structure comprises a sound-making torsion spring that is fixed to a key switch and used to store power for making a sound, and the sound-making torsion spring has a fixing arm and a sound-making arm that maintains downward tension; the sound-making structure further comprises a sound-making portion that is configured on the key switch, the sound-making portion has a striking end table and an inclined table located above the striking end table, and in its natural state, the sound-making arm abuts against the striking end table; a structural member on the switching plate is a convex column, which is configured to be adjacent to the sound-making arm of a corresponding key switch, and the convex column moves along with the switching plate and has an influence on whether the sound-making arm can store power and make a sound normally.

As a preferred option, the switch-fixing plate is provided with a sound-making power-storing convex table corresponding to a bottom portion of the sound-making arm; when the key switch is pressed down, an arm portion of the sound-making arm can be stopped by the convex table to store power until the inclined table pushes the sound-making arm away from the convex table to rapidly strike the striking end table and make a keystroke sound; a through hole that is opened on the switch-fixing plate and allows the convex table to pass through is a limit chute hole, and the convex table has a height greater than the sound-making arm; when the convex column is located at one end of the limit chute hole, it does not interact with the sound-making arm; when the convex column is moved to the other end of the limit chute hole, a side face of the convex column abuts against a side portion of the sound-making arm to bend the sound-making arm away from the sound-making power-storing convex table, so that the sound-making arm is not in contact with the sound-making power-storing convex table, and therefore cannot store power to make a sound.

As a preferred option, a through hole that is opened on the switch-fixing plate and allows the convex column to pass through is a limit chute hole; when the convex column is located at one end of the limit chute hole, a top portion of the convex column is located at a bottom portion of the sound-making arm; when the key switch is pressed down, the sound-making arm can be stopped by the top portion of the convex column to store power until the inclined table pushes the sound-making arm away from the top portion of the convex column to rapidly strike the striking end table and make a keystroke sound; when the convex column is moved to the other end of the limit chute hole, it is distal from the bottom portion of the sound-making arm, so that the sound-making arm is not in contact with the top portion of the convex column, and therefore cannot store power to make a sound.

As a preferred option, guide columns are configured at both ends of the switch-fixing plate, guide grooves in which the guide columns can be moved are opened at both ends of the switching plate, and both the guide grooves and the limit chute hole are kept in the same direction.

As a preferred option, an assembly frame is mounted on the bottom portion of the switch-fixing plate, and the switching plate is movably arranged between the switch-fixing plate and the assembly frame.

As a preferred option, the key switch comprises two linkage members that are pivotally connected to each other, a reset draw spring, and a key cap that is snapped onto the two linkage members, the reset draw spring is connected between the two linkage members, and the sound-making structure is configured on one of the linkage members; a structure for assembling the two linkage members is configured on the switch-fixing plate.

The beneficial effect of the present invention is as follows: the keyboard of the present invention is artful in arranging the movable switching plate at the bottom portion of the keyboard, so as to determine whether the sound-making structures in the key switches can make keystroke sounds by changing the positions of the structural members that are located on the switching plate and stretched into the key switches; according to the solution, the keyboard has two modes of sound and silence at the same time, can switch the two modes in a convenient and fast manner through the movement of the switching plate, and is delicate in design, high in stability, and easy to manufacture.

### BRIEF DESCRIPTION OF THE DRAWINGS

FIG. 1 is an exploded structure diagram of a switching plate and a switch-fixing plate in the present invention;

FIG. 2 is an enlarged view of a combination of a switch-fixing plate and a switching plate in Embodiment 1 of the present invention;

FIG. 3 is an enlarged view of a switch-fixing plate in Embodiment 1 of the present invention;

FIG. 4 is an enlarged view of a switch-fixing plate in Embodiment 2 of the present invention;

FIG. 5 is a structure diagram of a switching plate in the present invention;

FIG. 6 is an enlarged view of Position A in a switching plate in FIG. 5;

FIG. 7 is a partial exploded view of a key switch in the present invention;

FIG. 8 is a planar partial enlarged view of Position B in a sound-making structure in FIG. 7;

FIG. 9 is a structure diagram of Position B in the sound state in Embodiment 1 of the present invention;

FIG. 10 is a structure diagram of Position B in the silent state in Embodiment 1 of the present invention;

FIG. 11 is a structure diagram of Position B is in the sound state in Embodiment 2 of the present invention;

FIG. 12 is a structure diagram of Position B in the silent state in Embodiment 2 of the present invention;

FIG. 13 is a structure diagram of a bottom portion of the present invention;

FIG. 14 is a structure diagram of an assembly frame in the present invention.

In the figure: 1. switch-fixing plate; 101. through hole; 102. guide column; 103. fixing column; 2. key switch; 201. linkage member; 202. key cap; 3. sound-making structure; 301. sound-making torsion spring; 3011. fixing arm; 3012. sound-making arm; 302. sound-making portion; 3021. striking end table; 3022. inclined table; 4. switching plate; 401. guide groove; 5. sound-making power-storing convex table; 6. convex column; 7. assembly frame; 701. assembly hole.

### DETAILED DESCRIPTION OF THE INVENTION

In combination with the drawings and specific embodiments, the present invention will be further described below in detail. To describe the technical solution in a clear and complete manner, the following embodiments are selected for illustration; the following embodiments are some of embodiments of the present invention; other embodiments that are obtained based on the present application without creative labor fall within the scope of protection of the present invention.

In the following embodiments, it should be noted that orientations or positional relationships indicated by the terms such as “up”, “down”, “left”, “right”, “inside”, “outside”, and “top/bottom” are based on the orientations or positional relationships shown in the drawings, for the mere purpose of facilitating a clear description of these embodiment, rather than indicating or implying that the device or component referred to must have a specific orientation; therefore, the terms cannot be understood as limitations upon the present application. Furthermore, the terms “first” and “second” in the embodiments are only used for the purpose of distinguishing the description, and do not indicate or imply relative importance.

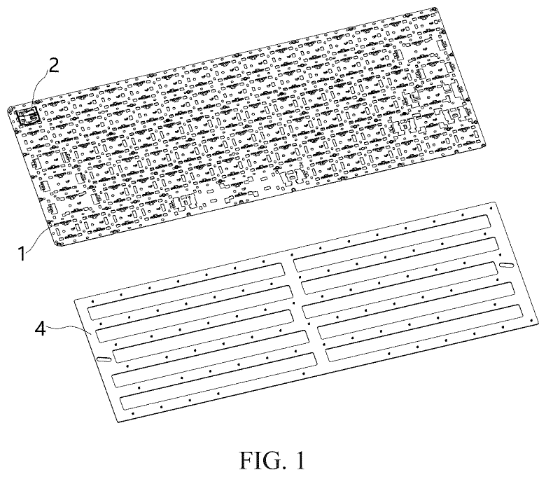

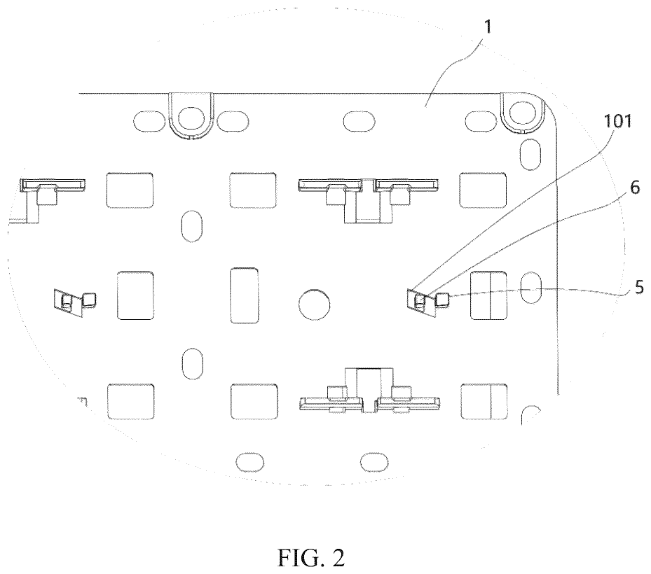

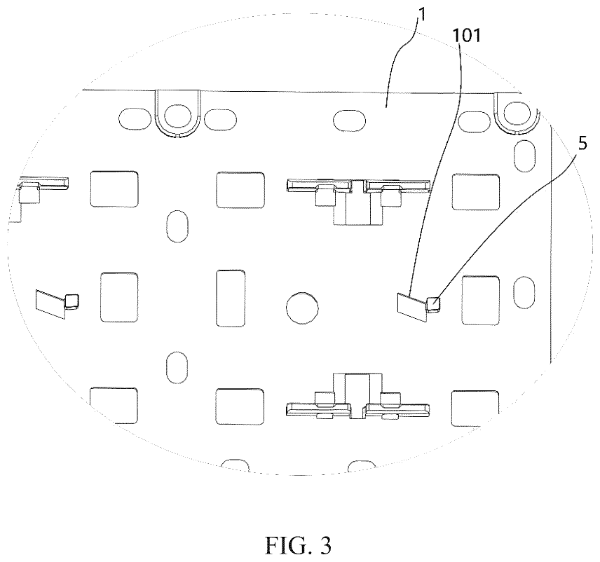

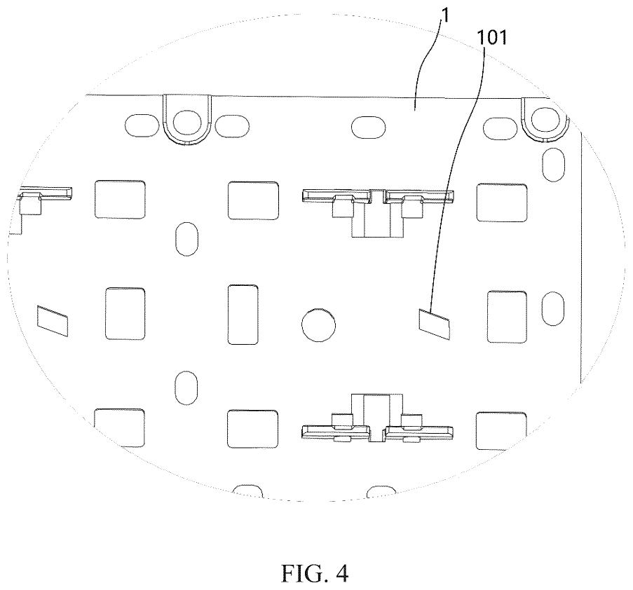

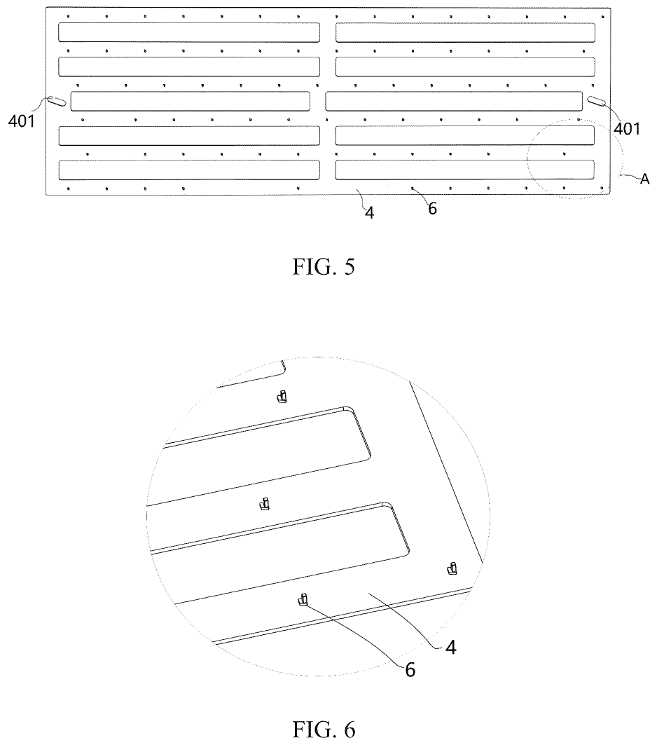

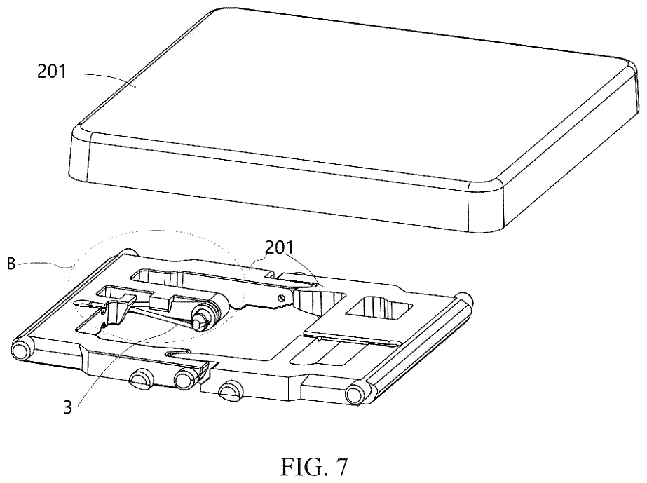

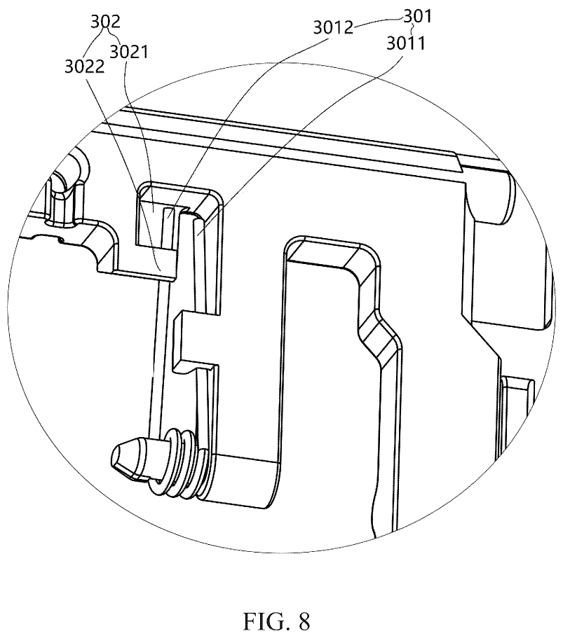

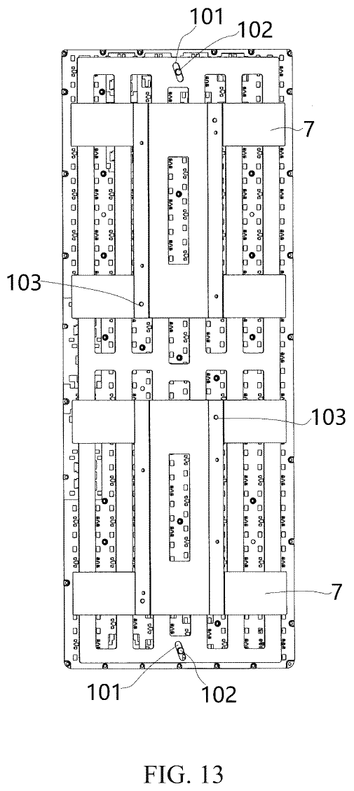

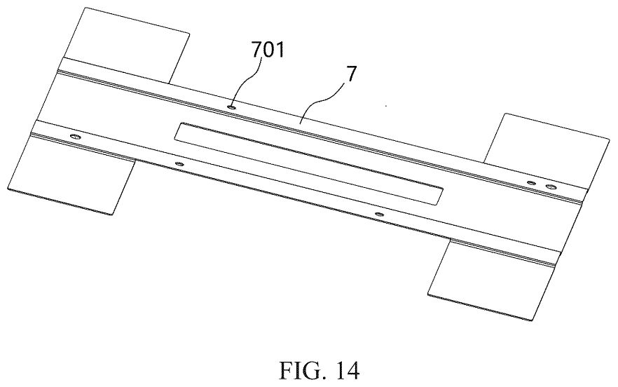

As shown in FIGS. 1-14, the embodiments of the present invention relate to a keyboard with a switchable keystroke sound. The keyboard comprises a switch-fixing plate 1 and a plurality of key switches 2 arranged on the switch-fixing plate 1. The key switches 2 each have a sound-making structure 3 for making a keystroke sound when pressed. A switching plate 4 that can be moved relative to the switch-fixing plate 1 is arranged at a bottom portion of the switch-fixing plate 1. A plurality of structural members that are stretched into the key switches 2 are configured on the switching plate 4. The structural members correspond one by one to the key switches 2. For the convenience of understanding, the present application only shows one key switch 2 in the figures. In fact, there are key switches 2 that correspond to the structural members one by one.

Through holes 101 that allow the structural members to enter corresponding key switches 2 and move along with the switching plate 4 are opened on the switch-fixing plate 2. Positions of the structural members in the corresponding key switches 2 can be changed by moving the switching plate 4, and the state of interaction between the structural members and the sound-making structures 3 is changed accordingly, so as to determine whether the sound-making structures 3 make sounds or stay silent when the key switches 2 are pressed.

The key switches 2 in the present solution can take a number of forms. The sound-making structures 3 are assembled in the key switches 2. Whether the sound-making structures 3 in the key switches 2 can make keystroke sounds is determined by changing the positions of the structural members that are located on the switching plate 4 and stretched into the key switches 2.

In the embodiments of the present solution, a key switch 2 comprises two linkage members 201 that are pivotally connected to each other, a reset draw spring, and a key cap 202 that is snapped onto the two linkage members 201. The reset draw spring is connected between the two linkage members 201. The sound-making structure 3 is configured on one of the linkage members 201. A structure for assembling the two linkage members 201 is configured on the switch-fixing plate 1. For the specific structure of the key, see the key adopted in the patent numbered “202223562053.1” and titled “ULTRATHIN BALANCE KEY WITH STABLE ASSEMBLY”, which will not be repeated herein. However, it should be noted that the present solution can at least be applied to the ultrathin balance key as mentioned above, but is not limited to the ultrathin balance key.

The sound-making structure 3 in the present embodiments comprises a sound-making torsion spring 301 that is fixed to the key switch 2 and used to store power for making a sound. The sound-making torsion spring 301 has a fixing arm 3011 and a sound-making arm 3012 that maintains downward tension. The sound-making structure 3 further comprises a sound-making portion 302 that is configured on the key switch 2. The sound-making portion 302 has a striking end table 3021 and an inclined table 3022 arranged above the striking end table 3021. In its natural state, the sound-making arm 3012 abuts against the striking end table 3021. The structural member on the switching plate 4 is a convex column 6. The convex column 6 is configured to be adjacent to the sound-making arm 3012 of a corresponding key switch 2. Moving along with the switching plate 4, the convex column 6 has an influence on whether the sound-making arm 3012 can store power and make a sound normally.

The present application provides two embodiments for switching the keystroke sound as follows.

### Embodiment 1 of the Present Application

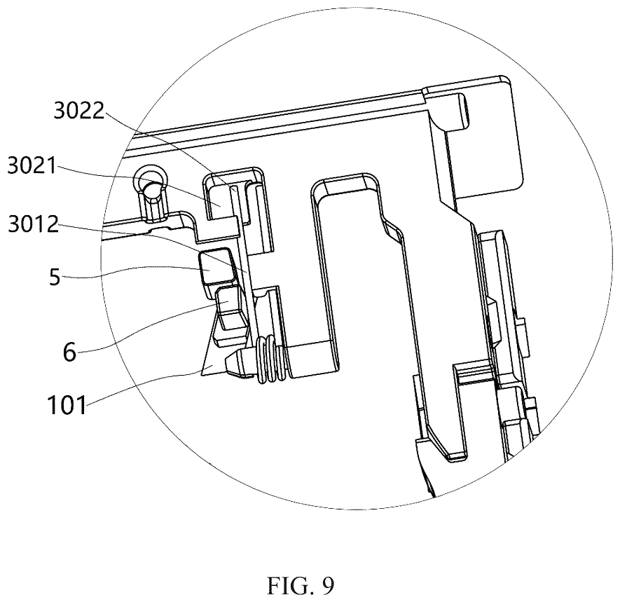

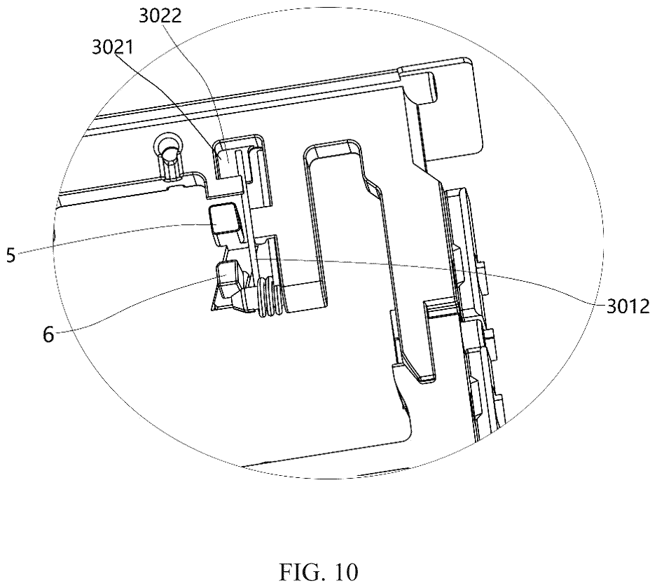

As shown in FIGS. 9-10, the switch-fixing plate 1 is provided with a sound-making power-storing convex table 5 corresponding to a bottom portion of the sound-making arm 3012. When the key switch 2 is pressed down, an arm portion of the sound-making arm 3012 can be stopped by the convex table to store power until the inclined table 3022 pushes the sound-making arm 3012 away from the convex table to rapidly strike the striking end table 3021 and make a keystroke sound. The through hole 101 that is opened on the switch-fixing plate 1 and allows the convex column 6 to pass through is a limit chute hole. The convex column 6 has a height greater than the sound-making arm 3012. When the convex column 6 is located at one end of the limit chute hole, it does not interact with the sound-making arm 3012. When the convex column 6 is moved to the other end of the limit chute hole, a side face of the convex column 6 abuts against a side portion of the sound-making arm 3012 to bend the sound-making arm 3012 away from the sound-making force-storing convex table 5, so that the sound-making arm 3012 is not in contact with the sound-making force-storing convex table 5, and therefore cannot store power to make a sound.

### Embodiment 2 of the Present Application

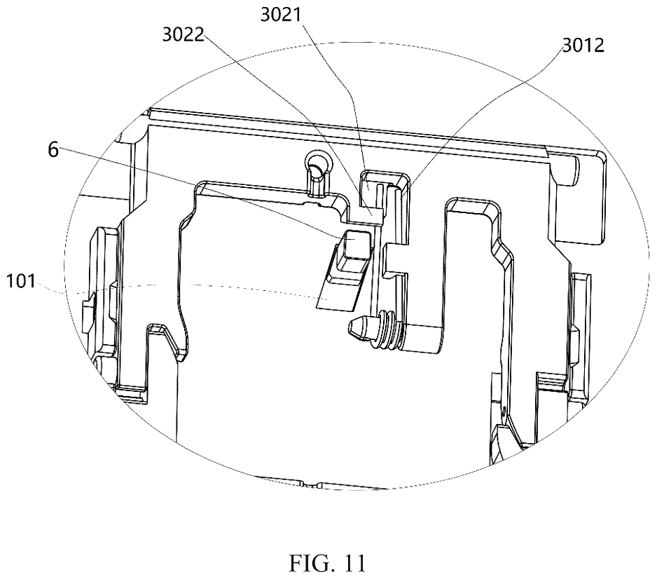

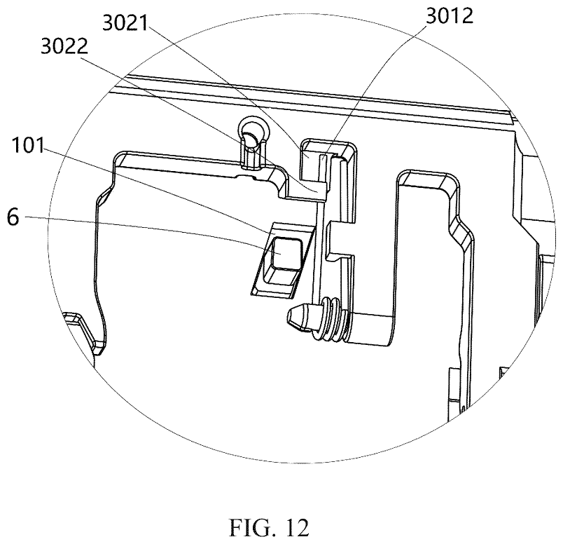

As shown in FIGS. 11-12, the through hole 101 that is opened on the switch-fixing plate 1 and allows the convex column 6 to pass through is a limit chute hole. When the convex column 6 is located at one end of the limit chute hole, a top portion of the convex column 6 is located at a bottom portion of the sound-making arm 3012. When the key switch 2 is pressed down, the sound-making arm 3012 can be stopped by the top portion of the convex column 6 to store power until the inclined table 3022 pushes the sound-making arm 3012 away from the top portion of the convex column 6 to rapidly strike the striking end table and make a keystroke sound. When the convex column 6 is moved to the other end of the limit chute hole, it is distal from the bottom portion of the sound-making arm 3012, so that the sound-making arm 3012 is not in contact with the top portion of the convex column 6, and therefore cannot store power to make a sound.

Guide columns 102 are arranged at both ends of the switch-fixing plate 1. Guide grooves 104 in which the guide columns 102 can be moved are opened at both ends of the switching plate 4, and both the guide grooves 401 and the limit chute hole are kept in the same direction, so that when the switching plate 4 is dragged, the whole convex column 6 is dragged and kept in the same direction. For the convenience of switching, preferably, a pull ring can also be arranged at one end of the switching plate 4, which facilitates dragging.

To assemble the switching plate 4 and enable it to slide on the bottom portion of the switch-fixing plate 1, an assembly frame 7 is mounted at the bottom portion of the switch-fixing plate 1. The switching plate 4 is movably arranged between the switch-fixing plate 1 and the assembly frame 7. Specifically, assembly holes 701 are arranged on the assembly frame 7, and fixing columns 103 that match the assembly holes 701 are arranged on the switch-fixing plate 1.

The above description only relates to preferred embodiments of the present invention, and is not intended to limit the present invention. Any minor modifications, equivalent substitutions, and improvements that are made to the above embodiments based on the technical essence of the present invention shall fall within the scope of protection of the technical solution of the present invention.

1. A keyboard with a switchable keystroke sound, comprising a switch-fixing plate and a plurality of key switches arranged on the switch-fixing plate, the key switches each having a sound-making structure for making a keystroke sound when pressed, characterized in that a switching plate that is movable relative to the switch-fixing plate is arranged at a bottom portion of the switch-fixing plate, a plurality of structural members that are stretched into the key switches are configured on the switching plate, and the structural members correspond one by one to the key switches;
through holes that allow the structural members to enter corresponding key switches and move along with the switching plate are opened on the switch-fixing plate; positions of the structural members in the corresponding key switches can be changed by moving the switching plate, and state of interaction between the structural members and sound-making structures is changed accordingly, so as to determine whether the sound-making structures make sounds or stay silent when the key switches are pressed; the sound-making structure comprises a sound-making torsion spring that is fixed to a key switch and used to store power for making a sound, and the sound-making torsion spring has a fixing arm and a sound-making arm that maintains downward tension; the sound-making structure further comprises a sound-making portion that is configured on the key switch, the sound-making portion has a striking end table and an inclined table located above the striking end table, and in its natural state, the sound-making arm abuts against the striking end table; a structural member on the switching plate is a convex column, which is configured to be adjacent to the sound-making arm of a corresponding key switch, and the convex column moves along with the switching plate and has an influence on whether the sound-making arm can store power and make a sound normally.

2. (canceled)

3. The keyboard with a switchable keystroke sound according to claim 1, characterized in that the switch-fixing plate is provided with a sound-making power-storing convex table corresponding to a bottom portion of the sound-making arm; when the key switch is pressed down, an arm portion of the sound-making arm can be stopped by the convex table to store power until the inclined table pushes the sound-making arm away from the convex table to rapidly strike the striking end table and make a keystroke sound; a through hole that is opened on the switch-fixing plate and allows the convex table to pass through is a limit chute hole, and the convex table has a height greater than the sound-making arm; when the convex column is located at one end of the limit chute hole, it does not interact with the sound-making arm; when the convex column is moved to the other end of the limit chute hole, a side face of the convex column abuts against a side portion of the sound-making arm to bend the sound-making arm away from the sound-making power-storing convex table, so that the sound-making arm is not in contact with the sound-making power-storing convex table, and therefore cannot store power to make a sound.

4. The keyboard with a switchable keystroke sound according to claim 1 characterized in that a through hole that is opened on the switch-fixing plate and allows the convex column to pass through is a limit chute hole; when the convex column is located at one end of the limit chute hole, a top portion of the convex column is located at a bottom portion of the sound-making arm; when the key switch is pressed down, the sound-making arm can be stopped by the top portion of the convex column to store power until the inclined table pushes the sound-making arm away from the top portion of the convex column to rapidly strike the striking end table and make a keystroke sound; when the convex column is moved to the other end of the limit chute hole, it is distal from the bottom portion of the sound-making arm, so that the sound-making arm is not in contact with the top portion of the convex column, and therefore cannot store power to make a sound.

5. The keyboard with a switchable keystroke sound according to claim 4, characterized in that guide columns are configured at both ends of the switch-fixing plate, guide grooves in which the guide columns can be moved are opened at both ends of the switching plate, and both the guide grooves and the limit chute hole are kept in the same direction.

6. The keyboard with a switchable keystroke sound according to claim 5, characterized in that an assembly frame is mounted on the bottom portion of the switch-fixing plate, and the switching plate is movably arranged between the switch-fixing plate and the assembly frame.

7. The keyboard with a switchable keystroke sound according to claim 6, characterized in that the key switch comprises two linkage members that are pivotally connected to each other, a reset draw spring, and a key cap that is snapped onto the two linkage members, the reset draw spring is connected between the two linkage members, and the sound-making structure is configured on one of the linkage members; a structure for assembling the two linkage members is configured on the switch-fixing plate.
